(19) United States
(12) Patent Application Publication
(10) Pub. No.: US 2023/0325680 A1
(43) Pub. Date: Oct. 12, 2023

(54) CHROMOSOME EXPIRATION

(71) Applicants: Hewlett-Packard Development Company, L.P., Spring, TX (US); Instituto Atlântico, Edson Queiroz, Fortaleza (BR)

(72) Inventors: Juan Carlos CATANA SALAZAR, San Diego, CA (US); Alyne GOMES SOARES CANTAL, Porto Alegre (BR); Scott Alan WHITE, Boise, ID (US); Andre Luiz LIMA PEDRO, Porto Alegre (BR); Jun Zeng, Palo Alto, CA (US)

(21) Appl. No.: 18/024,475

(22) PCT Filed: Sep. 4, 2020
(86) PCT No.: PCT/US2020/049537

§ 371 Date: Mar. 2, 2023

(51) Int. Cl. G06N 3/126; B33Y 50/00

(52) U.S. Cl. CPC G06N 3/126; B33Y 50/00

(57) ABSTRACT

Examples of methods for determining chromosome expiration are described herein. In some examples, a method includes generating, in a genetic procedure, chromosomes indicating object packing positions. In some examples, the method includes determining whether a chromosome of the chromosomes is expired. In some examples, the method includes excluding the chromosome from a subsequent generation in response to determining that the chromosome is expired.

### BACKGROUND

Three-dimensional (3D) solid objects may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final object. In some additive manufacturing techniques, the build material may be cured or fused.

### BRIEF DESCRIPTION OF THE DRAWINGS

FIG. 1 is a flow diagram illustrating an example of a method for determining chromosome expiration;

FIG. 2 is a block diagram of an example of an apparatus that may be used in determining chromosome expiration;

FIG. 3 is a block diagram illustrating an example of a computer-readable medium for determining a packing;

FIG. 4 is a graph illustrating a plot of packing density over generations for a set of chromosome experiments without chromosome expiration; and

FIG. 5 is a flow diagram illustrating an example of a method to select a packing.

### DETAILED DESCRIPTION

Additive manufacturing may be used to manufacture three-dimensional (3D) objects. 3D printing is an example of additive manufacturing. Performing additive manufacturing may rely on a packing. A packing is information that specifies an arrangement (e.g., position, location, orientation, etc.) of objects in a build volume. A build volume is a 3D space. A build volume may correspond to a physical space in which additive manufacturing may be performed. It may be helpful to increase packing density in the build volume to increase production and/or reduce manufacturing costs.

In some examples, object packing may be based on an objective or objectives. An example of an objective is packing density (e.g., increasing or maximizing packing density). Object packing questions may be computationally intensive to solve, being nondeterministic polynomial—(NP-) complete. For example, computational complexity may grow exponentially in NP-complete questions. For instance, the size of the solution space (e.g., number of possible packing arrangements) for placement of objects (without rotation, for example) in a relatively small batch of 20 objects, is beyond the order of 1×10¹⁸. Some examples of the techniques described herein may provide practical and/or near-optimal approaches for object packing. For instance, some of the techniques described herein may enable searching over the solution space while prioritizing portions that have a greater probability of producing a near-optimal solution. In some examples, a relatively small portion of the solution space may be searched.

Throughout the drawings, identical or similar reference numbers may designate similar, but not necessarily identical, elements. When an element is referred to without a reference number, this may refer to the element generally, without necessary limitation to any particular Figure. The figures are not necessarily to scale, and the size of some parts may be exaggerated to more clearly illustrate the example shown. Moreover, the drawings provide examples in accordance with the description; however, the description is not limited to the examples provided in the drawings.

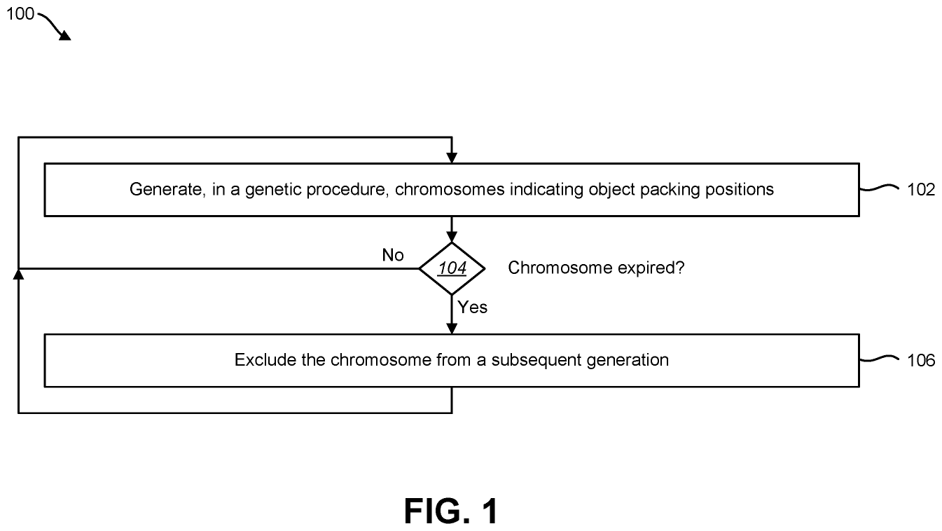

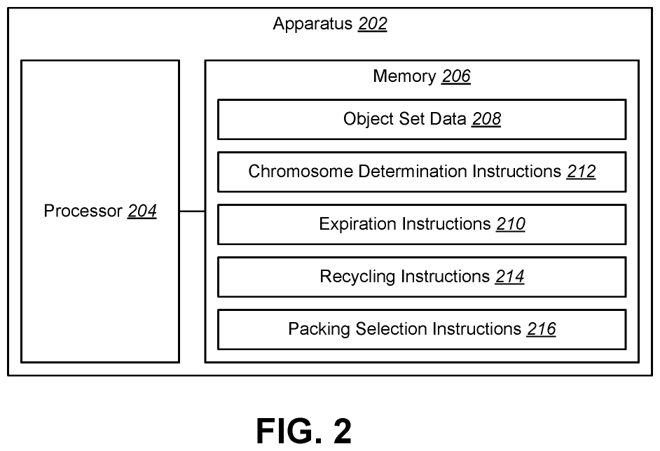

FIG. 1 is a flow diagram illustrating an example of a method 100 for determining chromosome expiration. The method 100 and/or a method 100 element or elements may be performed by an apparatus (e.g., electronic device). For example, the method 100 may be performed by the apparatus 202 described in relation to FIG. 2.

The apparatus may generate 102, in a genetic procedure, chromosomes indicating object packing positions. A genetic procedure is a computational procedure. For example, a genetic procedure may be a metaheuristic procedure that includes evolution and/or selection mechanisms for determining a solution. In some examples, a genetic procedure may be a technique utilized in artificial intelligence. In some examples, the genetic procedure may include initializing a population, evaluation, selection, crossover, and/or mutation operations. In some examples, evaluation, selection, crossover, and/or mutation may be performed repeatedly (e.g., iteratively, recursively, etc.) until an end condition is met. In some examples, generating 102 the chromosomes may be performed in initializing a population, crossover, and/or mutation operations. A population is a group or set of chromosomes.

A chromosome is data. For example, a chromosome may include data representing a potential solution for a question that the genetic procedure is to address. For instance, chromosomes may indicate packing positions. A packing position is a pose of an object in a build volume. In some examples, a chromosome may include data indicating a set of object identifiers and poses. An object identifier is information (e.g., number, floating point number, integer, string, character(s), name, etc.) that identifies an object. A pose is information indicating a location and/or orientation of an object. For instance, a pose may indicate a location (e.g., translation) of an object in a build volume and/or an orientation (e.g., rotation(s) in a dimension or dimensions) of an object in a build volume. In some examples, a pose may be expressed as a number or numbers (e.g., floating point numbers, integers, etc.), vector(s), matrix or matrices, quaternion(s), etc. In some examples, a chromosome may include an object identifier with a first axis rotation (e.g., x), a second axis rotation (e.g., y), and a third axis rotation (e.g., z) for each of a set of objects. In some examples, a chromosome may include data for each object in an order or sequence. In some examples, the order or sequence may establish a priority queue. For instance, the order or sequence may indicate an order that objects may be introduced into a build volume. In some examples, the order or sequence may identify a chromosome. For instance, the order or sequence may remain the same through some changes to the chromosome (e.g., in some types of mutations). In some examples, a chromosome may include an object identifier and rotations for respective objects from object 1 to object n. In some examples, the order or sequence of a chromosome may be an order or sequence of object identifiers. For instance, the order or sequence of object identifiers of a chromosome may identify the chromosome. A chromosome identifier is a value (e.g., number, vector, list, set of numbers, ordered quantities, concatenated object identifiers, etc.) that identifies a chromosome. For example, a chromosome identifier may be the order or sequence (e.g., order or sequence of object identifiers). In some examples, a set of chromosomes may represent a set of potential packings described as a sequence of object identifiers with associated poses.

In initializing a population, the apparatus may randomly initialize a set of chromosomes. For example, the apparatus may utilize a random number generator to generate random poses for a set of objects (to be packed in a build volume, for instance).

In performing evaluation, the apparatus may evaluate and/or rank the chromosomes according to a fitness measure. A fitness measure is a measure that indicates a degree to which a chromosome (e.g., packing) satisfies an objective or objectives (e.g., increased packing density, increased number of objects packed, decreased packing height and/or z-axis measure, etc.). For example, the fitness measure may be evaluated for each chromosome (e.g., packing). Examples of fitness measures may include packing density, number of objects packed, and/or packing height (e.g., z-height). In some examples, the fitness measure may be utilized to rank or order chromosomes. In some examples, a group of fitness measures or parameters may be assembled to form a packing score that can be utilized to rank one packing over another packing. In some examples, chromosomes with relatively greater packing density, a relatively greater number of objects packed, and/or a relatively lesser packing height may be ranked higher than other chromosomes.

In performing selection, the apparatus may eliminate a portion of the chromosomes. For instance, the apparatus may eliminate (e.g., discard, delete, remove, exclude, etc.) a portion of the lowest ranked chromosomes (e.g., a percentage of lowest ranked chromosomes, a quantity of lowest ranked chromosomes, etc.). In some examples, the chromosomes may be categorized based on rank. For example, a first portion (e.g., percentage of chromosomes, number of chromosomes, etc.) of the chromosomes may be categorized in a first category. For instance, the first portion may be a set of highest ranked chromosomes. The first portion of chromosomes may be referred to as elite chromosomes (e.g., a portion of chromosomes with best fitness measures). In some examples, a gene or genes (e.g., object identifier(s) and/or pose(s)) of the elite chromosomes may be preserved and/or propagated to a subsequent (e.g., next) generation of chromosomes. A generation is a set of chromosomes (e.g., packings). For example, a generation may correspond to each iteration of the genetic procedure.

In performing crossover, the apparatus may utilize a second portion of chromosomes and elite chromosomes. The second portion of the chromosomes may be referred to as crossover chromosomes. The second portion of chromosomes may be ranked below the elite chromosomes. For instance, the apparatus may randomly select chromosomes that are ranked below the elite chromosomes to select the crossover chromosomes. The apparatus may crossover the crossover chromosomes with the elite chromosomes. For example, the apparatus may combine a portion or portions (e.g., gene(s), object identifier(s), pose(s), location(s), rotation(s), and/or sequence position(s)) of an elite chromosome with a portion or portions (e.g., gene(s), object identifier(s), pose(s), location(s), rotation(s), and/or sequence position(s)) of a crossover chromosome to generate a child chromosome in a subsequent (e.g., next) generation of chromosomes.

In performing mutation, the apparatus may randomly mutate an elite chromosome or elite chromosomes. For example, the apparatus may randomly change a gene or genes (e.g., object identifier(s), pose(s), location(s), rotation(s), and/or sequence position(s)) of an elite chromosome or elite chromosomes. The chromosomes to be mutated may be referred to as mutation chromosomes.

In some examples, a constant population size (e.g., number of chromosomes) may be maintained over generations. In some examples, the population size may vary over generations. In some examples, new random chromosomes may be added. For instance, a set of randomly generated chromosomes may be added to the elite chromosomes, crossover chromosomes, and mutation chromosomes. For instance, adding new random chromosomes may maintain the constant population size. The random chromosomes may be useful for driving a random search in different directions in the solution space. In some approaches, mutations of chromosomes may be represented as random movements in the object sequence and/or random rotations on the object orientations. The mutation stage may be utilized to mutate elite chromosomes (e.g., good solutions) into chromosomes with increased fitness (e.g., better solutions). Performing selection, crossover, and/or mutation may produce a subsequent generation of chromosomes.

In some cases, mutating a chromosome by applying random movements on the object sequence and/or applying random rotations on the orientation (e.g., x, y, and/or z axes) may result in creating new chromosomes with little or no relation with previous generations (e.g., no optimization of chromosomes along the generations). On the other hand, mutations of elite chromosomes with a low degree of randomness may result in duplicated solutions or solutions with similar characteristics (e.g., comparable fitness measures). In some cases, mutations of elite chromosomes after a quantity (e.g., a relatively large amount) of generations may lead to worse solutions. For instance, after applying an amount of mutations on a particular chromosome, the chromosome may converge on fitness, where the chromosome is less likely to increase the fitness measure in future mutations. Some examples of the techniques described herein may be utilized to address these issues.

In some examples, the method 100 may include maintaining age information for each of the chromosomes. Age information may indicate an age of a chromosome. An age of a chromosome may be expressed as a generation number in which the chromosome was created and/or as an amount of generations since the chromosome was created. For instance, generating 102 chromosomes may include associating an age (e.g., 0, 1, generation number, etc.) with a new chromosome or chromosomes, updating an age of a chromosome or chromosomes (e.g., incrementing the age of a chromosome), and/or calculating an age of a chromosome (e.g., determining a difference between a current generation and a first generation in which the chromosome was created).

In some examples, a chromosome identifier (e.g., an order or sequence of object identifiers) may be utilized to initialize and/or maintain (e.g., calculate, increment, and/or track, etc.) an age of a chromosome. In some examples, when a new chromosome is created and/or when a change (e.g., some types of mutation, crossover, etc.) produces a new chromosome, the age may be initialized to a value (e.g., 0, 1, generation number, etc.). In some examples, a random mutation may affect the chromosome identifier (e.g., order or sequence of object identifiers) and/or an object pose or poses (e.g., rotations on x, y, and/or z), thereby creating a new chromosome. In some examples, a recycling mutation may affect the chromosome identifier (e.g., order or sequence of object identifiers) by preserving a first portion of an expired chromosome and making a random change or changes to a second portion, thereby creating a new chromosome. When a random mutation and/or recycling mutation creates a new chromosome, an age of the chromosome may be initialized.

In some examples, when a chromosome identifier (e.g., order or sequence of object identifiers) is unchanged to a subsequent generation (e.g., genetic procedure iteration, recurrence), the corresponding chromosome may age. For instance, the age of the chromosome may be incremented and/or may indicate an older chromosome (e.g., a difference between a current generation number and a generation in which the chromosome was created may indicate an older chromosome). In some examples, the chromosome may increase in age through a mutation (e.g., pose mutation and/or optimization mutation). For instance, a pose mutation or optimization mutation may affect the pose (e.g., location and/or orientation or rotation(s) in x, y, and/or z) without affecting the chromosome identifier (e.g., order or sequence of object identifiers of the chromosome). Accordingly, when a chromosome identifier is maintained through a mutation (into a subsequent generation, for instance), the chromosome age may increase.

In some examples, the method 100 may include storing chromosome identifiers or values (e.g., hashes) associated with chromosome identifiers and corresponding fitness measures. For instance, the apparatus may store chromosome identifiers and/or associated values with corresponding fitness measures in a data structure (e.g., lookup table, database, array, hash table, etc.). In some examples, the apparatus may utilize a hash function to store hashes associated with chromosome identifiers and corresponding fitness measures and/or fitness scores. For instance, the apparatus may input the chromosome identifier into a hash function to produce an associated hash. In some examples, the apparatus may store the hash with a fitness measure corresponding to the chromosome in a data structure (e.g., lookup table, hash table, etc.). In some examples, the apparatus may determine whether a chromosome or chromosomes in a new generation (e.g., after mutation) is the same as a chromosome with a previously calculated fitness measure. For instance, the apparatus may attempt to look up a fitness measure using a chromosome identifier (e.g., hash) and/or poses. If the chromosome matches an earlier chromosome, the fitness measure may be looked up (instead of being recalculated in evaluation, for instance), which may reduce processing in some examples. In some examples, the look up may be performed for unexpired chromosomes.

The apparatus may determine 104 whether a chromosome is expired. A chromosome may be expired if an expiration criterion is met and/or expiration criteria are met. An expiration criterion is a condition that indicates whether a chromosome is expired. Examples of expiration criteria include chromosome age and slope.

In some examples, determining 104 whether the chromosome is expired is based on an age of the chromosome. For instance, determining 104 whether the chromosome is expired may be based on comparing the age (of a chromosome) to an age threshold. In some examples, the age threshold may be expressed in units of generations. For instance, the age threshold may be 50, 75, 100, 105, 133, 150, etc. In some examples, if the age is greater than or at least the age threshold, the chromosome may be determined to be expired.

In some examples, the method 100 may include determining a slope of fitness measure (e.g., packing density) and generation. For instance, the apparatus may calculate a slope for a chromosome or chromosomes. In some examples, a slope may be calculated as the fitness measure over generation. For instance, the slope may be calculated as

$$\frac{{Fitness}_{B} - {Fitness}_{A}}{{Generation}_{B} - {Generation}_{A}} ,$$

where Fitness_{B} is a fitness measure for a chromosome at a generation (e.g., current generation), Fitness_{A} is a fitness measure for a chromosome at a previous generation (e.g., an earlier generation that may be a generation or generations previous to the current generation), Generation_{B} is the generation (e.g., current generation) of the chromosome, and Generation_{A} is the previous generation (e.g., an earlier generation that may be a generation or generations previous to the current generation) of the chromosome.

In some examples, determining 104 whether the chromosome is expired is based on the slope (of the chromosome, for instance). For instance, determining 104 whether the chromosome is expired may be based on comparing the slope (of a chromosome) to a slope threshold. In some examples, the slope threshold may be expressed in units of fitness measure over generation. For packing density over generation, for instance, examples of the slope threshold may be 0.000005, 0, −0.000005, etc. In some examples, if the slope is less than or not more than the slope threshold, the chromosome may be determined to be expired.

In a case that the chromosome is not expired, the method 100 may return to generating 102, in the genetic procedure, chromosomes indicating object packing positions. For instance, a non-expired chromosome may be utilized in generating 102 a subsequent generation of chromosomes.

In a case that the chromosome is expired, the apparatus may exclude 106 the chromosome from a subsequent generation. For instance, the apparatus may remove the expired chromosome from consideration in generating 102 chromosomes in a subsequent generation.

In some examples, the method 100 may include randomly rotating poses of a selected chromosome. For instance, elite chromosomes may be potential solutions that may be optimized along the generations. During the lifecycle of an elite chromosome, the apparatus may apply optimization mutations. An optimization mutation is a mutation that maintains object ordering while mutating pose (e.g., location and/or rotation). For example, the apparatus may select a random subset of objects that are randomly rotated. In some examples, rotations allowed for optimization mutation may be limited to rotation quanta (e.g., rotations of 90 degrees, 45 degrees, etc.). In some examples, a percentage threshold may be established on the subset of objects to be rotated. In some examples, the percentage threshold may be based on the size of the chromosome (e.g., number of objects) and their rotation quanta. The optimization mutation may maintain the chromosome property given by the object ordering. The random rotations may be utilized to increase packing fitness (e.g., packing density, number of packed objects, and/or z-height, etc.) on a chromosome.

In some examples, the method 100 may include generating a recycled chromosome based on a portion of an expired chromosome. A seed portion of an expired chromosome is a portion to be maintained. For instance, an expired chromosome may be divided into two sections. A first section may be the seed portion and may include m genes (e.g., the first m genes). The second section may include the non-seed genes (e.g., remainder of the genes). In some examples, the apparatus may create a new recycled chromosome by utilizing the seed portion of an expired chromosome and filling the rest of the chromosome with randomized portions. The new recycled chromosome may inherit partial optimization of previous generations. In some examples, generating a recycled chromosome may be referred to as a recycling mutation. In some examples, generating a recycled chromosome may include maintaining all or a portion of object sequence information in an expired chromosome without randomization.

In some examples, the method 100 may include selecting based on the chromosomes (e.g., chromosomes after a generation or generations). In some examples, selecting the packing is based on the genetic procedure with an objective to increase packing density. For instance, the apparatus may select a chromosome that represents a packing with a highest ranking and/or best fitness measure. In some examples, the apparatus may select the packing based on an objective (e.g., packing density) or a combination of objectives. For instance, a packing with a best combination of objectives, such as packing density and packing height, may be selected.

In some examples, the packing may be executed to manufacture the objects. For example, the objects may be manufactured by an apparatus (e.g., 3D printer) in accordance with the selected packing. For instance, an apparatus may send the packing to another device (e.g., 3D printer) or may execute the packing to manufacture the objects in the packing. It should be noted that some examples of the techniques described herein may be utilized in a variety of additive manufacturing. Some additive manufacturing techniques may be powder-based and driven by powder fusion. Some additive manufacturing techniques may include metal printing, such as metal jet fusion. Some examples of the approaches described herein may be utilized in powder bed fusion-based additive manufacturing, such as Selective Laser Melting (SLM), Selective Laser Sintering (SLS), Multi-Jet Fusion (MJF), etc.

FIG. 2 is a block diagram of an example of an apparatus 202 that may be used in determining chromosome expiration. The apparatus 202 may be an electronic device, such as a personal computer, a server computer, a printer, a 3D printer, a smartphone, a tablet computer, etc. The apparatus 202 may include and/or may be coupled to a processor 204 and/or a memory 206. In some examples, the apparatus 202 may be in communication with (e.g., coupled to, have a communication link with) an additive manufacturing device (e.g., a 3D printing device). In some examples, the apparatus 202 may be an example of a 3D printing device. The apparatus 202 may include additional components (not shown) and/or some of the components described herein may be removed and/or modified without departing from the scope of the techniques described herein.

The processor 204 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 206. The processor 204 may fetch, decode, and/or execute instructions (e.g., chromosome determination instructions 212, expiration instructions 210, recycling instructions 214, and/or packing selection instructions 216) stored in the memory 206. In some examples, the processor 204 may include an electronic circuit or circuits that include electronic components for performing a function or functions of the instructions (e.g., chromosome determination instructions 212, expiration instructions 210, recycling instructions 214, and/or packing selection instructions 216). In some examples, the processor 204 may perform one, some, or all of the functions, operations, elements, methods, etc., described in relation to one, some, or all of FIGS. 1-5.

The memory 206 may be any electronic, magnetic, optical, or other physical storage device that contains or stores electronic information (e.g., executable instructions, executable code, and/or data). The memory 206 may be, for example, Random Access Memory (RAM), Electrically Erasable Programmable Read-Only Memory (EEPROM), a storage device, an optical disc, and the like. In some examples, the memory 206 may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 206 may be a non-transitory tangible machine-readable storage medium, where the term “non-transitory” does not encompass transitory propagating signals. In some examples, the memory 206 may include multiple devices (e.g., a RAM card and a solid-state drive (SSD)).

In some examples, the apparatus 202 may include an input/output interface (not shown in FIG. 2) through which the processor 204 may communicate with an external device or devices (not shown), for instance, to receive and store information (e.g., object set data 208) pertaining to an object or objects to be manufactured (e.g., printed). The input/output interface may include hardware and/or machine-readable instructions to enable the processor 204 to communicate with the external device or devices. The input/output interface may enable a wired or wireless connection to the external device or devices. The input/output interface may further include a network interface card and/or may also include hardware and/or machine-readable instructions to enable the processor 204 to communicate with various input and/or output devices, such as a keyboard, a mouse, a display, another apparatus, electronic device, computing device, etc., through which a user may input instructions into the apparatus 202.

In some examples, the memory 206 may store object set data 208. The object set data 208 may be obtained (e.g., received) from an external device and/or may be generated on the apparatus 202. For example, the processor 204 may execute instructions (not shown in FIG. 2) to receive the object set data 208 from an external device.

The object set data 208 may include data indicating objects and/or shapes (e.g., 3D models, dimensions, etc.) of objects. For example, the objects set data 208 may indicate a set of objects for packing and/or manufacture.

In some examples, the processor 204 may execute the chromosome determination instructions 212 to determine a set of chromosomes (e.g., packings) in a population based on object set data 208. For example, the processor 204 may execute a genetic procedure to determine the set of chromosomes. In some examples, determining the set of chromosomes may include randomizing chromosomes and/or propagating (e.g., inheriting) chromosomes. For instance, the processor 204 may randomize object pose (e.g., location and/or orientation) in a build volume.

In some examples, the processor 204 may execute expiration instructions 210 to determine that a chromosome in a genetic procedure is expired. In some examples, determining that a chromosome is expired may be performed as described in relation to FIG. 1. For instance, the processor 204 may determine that the chromosome is expired based on a slope of packing density over generation of the genetic procedure.

In some examples, the processor 204 may execute the recycling instructions 214 to generate a recycled chromosome based on a seed portion of the expired chromosome. In some examples, generating the recycled chromosome may be performed as described in relation to FIG. 1. For example, the processor 204 may maintain a seed portion of the expired chromosome and randomize a gene or genes in a non-seed portion of the expired chromosome to produce the recycled chromosome.

In some examples, the processor 204 may execute the packing selection instructions 216 to select a packing based on the recycled chromosome. For example, the processor 204 may select the packing as a packing with a best fitness measure from a set of chromosomes that includes the recycled chromosome. For instance, the processor 204 may select the packing as a packing with a greatest packing density from a set of chromosomes that includes the recycled chromosome.

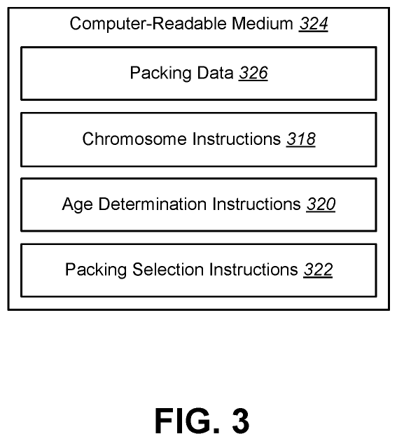

FIG. 3 is a block diagram illustrating an example of a computer-readable medium 324 for determining a packing. The computer-readable medium is a non-transitory, tangible computer-readable medium 324. The computer-readable medium 324 may be, for example, RAM, EEPROM, a storage device, an optical disc, and the like. In some examples, the computer-readable medium 324 may be volatile and/or non-volatile memory, such as DRAM, EEPROM, MRAM, PCRAM, memristor, flash memory, and the like. In some examples, the memory 206 described in relation to FIG. 2 may be an example of the computer-readable medium 324 described in relation to FIG. 3.

The computer-readable medium 324 may include code (e.g., data and/or instructions). For example, the computer-readable medium 324 may include packing data 326, chromosome instructions 318, age determination instructions 320, and/or packing selection instructions 322.

The packing data 326 may include information indicating a plurality of packings. For example, the packing data 326 may indicate a set of packings, a group of packings, a population of packings, and/or generations of packings. For instance, operations may be performed as described herein to determine a plurality of chromosomes that represent packings. The chromosomes may be stored as packing data 326.

In some examples, the chromosome instructions 318 are code to cause a processor to create a chromosome and initialize an age associated with the chromosome. For instance, the chromosome instructions 318 may be instructions to cause a processor to generate a chromosome, crossover chromosomes, and/or mutate a chromosome to create the chromosome. In some examples, the chromosome instructions 318 may initialize an age associated with the chromosome. For example, the chromosome instructions 318 may include code to cause a processor to store (in the computer readable medium 324 and/or other memory) a generation associated with the created chromosome (e.g., the generation at which the chromosome was created). In some examples, the chromosome may be created as described in relation to FIG. 1 and/or FIG. 2.

In some examples, the chromosome instructions 318 may include code to cause the processor to randomly select a subset of the chromosome. For instance, the subset of the chromosome may be selected during the lifetime of the chromosome (e.g., before the age reaches an age threshold). In some examples, the chromosome instructions 318 may include code to cause the processor to randomly rotate poses of the subset (e.g., selected subset) of the chromosome. For instance, the poses of the selected subset may be rotated during the lifetime of the chromosome (e.g., before the age reaches an age threshold). In some examples, randomly selecting the subset and/or randomly rotating poses of the selected subset may be performed as described in relation to FIG. 1 and/or FIG. 2.

In some examples, the age determination instructions 320 are code to cause the processor to increment the age for each generation of a genetic procedure. For example, the processor may execute the age determination instructions 320 to add a number (e.g., 1) to the age for each generation in which the chromosome is included and/or to calculate the age for each generation as a difference between a current generation and the generation in which the chromosome was created. In some examples, incrementing the age of the chromosome may be accomplished as described in relation to FIG. 1 and/or FIG. 2.

In some examples, the age determination instructions 320 are code to cause the processor to exclude the chromosome in a case that the age reaches an age threshold. For example, the processor may execute the age determination instructions 320 to compare the age of the chromosome to an age threshold. In a case that the age of the chromosome has reached an age threshold, the chromosome may be excluded. In some examples, excluding the chromosome may be accomplished as described in relation to FIG. 1 and/or FIG. 2. In some examples, the chromosome instructions 318 may include code to cause the processor to randomize a portion of the chromosome in the case that the age reaches the age threshold to produce a recycled chromosome. For instance, randomizing the portion of an expired chromosome may be performed as described in relation to FIG. 1 and/or FIG. 2.

In some examples, the packing selection instructions 322 are code to cause the processor to determine a packing based on a set of chromosomes that excludes the chromosome. For instance, the packing selection instructions 322 may cause a processor to determine a best packing in terms of packing efficiency and/or packing height from a set of chromosomes that does not include an expired chromosome. In some examples, determining the packing may be performed as described in relation to FIG. 1 and/or FIG. 2.

To determine a packing in some examples, packing scores may be compared. A packing score is a score indicating a fitness measure or a combination of fitness measures. An example of packing selection is given as follows. Assume two packings A and B with corresponding packing scores s_A and s_B. In some examples, a packing score s_X may include parameters (e.g., k parameters or fitness measures): s_X={p1_X, p2_X, . . . , pk_X}, where px_X is a parameter or fitness measure. A quantity (e.g., k) of threshold values may be utilized: α, β, . . . , φ. If the first k−1 parameters of each packing are relatively closer to each other (up to an adjustable threshold), a Boolean value of (p1_A>p1_B) may indicate whether s_A is greater than s_B. For instance, In a case that abs(p1_A−p1_B)<α and abs(p2_A−p2_B)<β and so on for the rest of the parameters, and (pk_A !=pk_B), then a Boolean value of (pk_A>pk_B) may indicate whether s_A is greater than s_B. Otherwise, a parameter number k−1 may be compared. For instance, in a case that abs(p1_A−p1_B)<α and abs(p2_A−p2_B)<β and so on for the rest of the parameters, and (pk−1_A !=pk−1_B), then a Boolean value of (pk−1_A>pk−1_B) may indicate whether s_A is greater than s_B. Otherwise, similar comparisons may be made for a parameter or parameters (e.g., pk−2_A !=pk−2_B and so on) until the final case, where (p1_A>p1_B) may indicate whether s_A is greater than s_B. The packing with the greatest score may be selected. It should be noted that one parameter or multiple parameters may be utilized in the comparison.

In some examples, the computer-readable medium 324 may include code for causing a processor to manufacture the selected packing. For example, the code may cause a processor to execute instructions and/or send instructions to another device (e.g., 3D printer) to manufacture the selected packing.

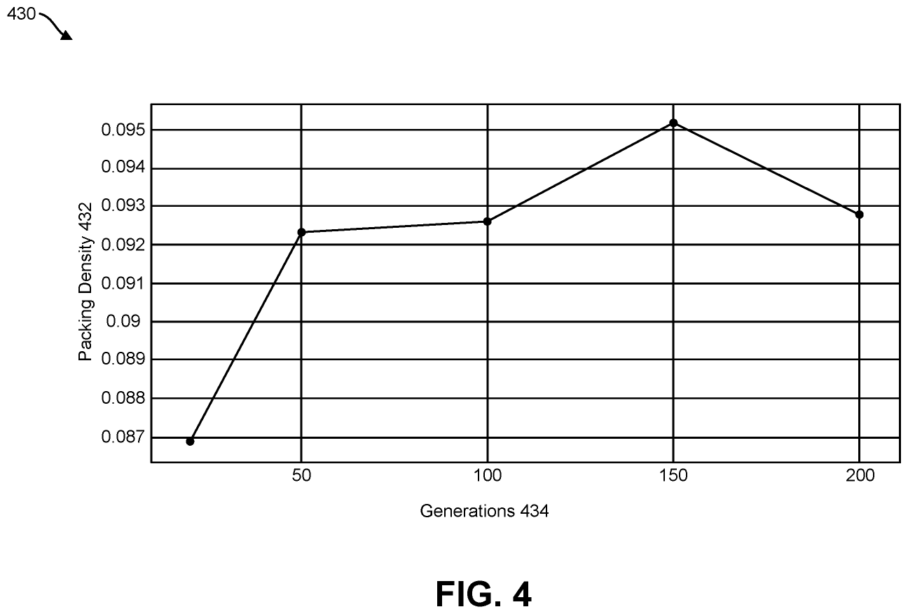

FIG. 4 is a graph 430 illustrating a plot of packing density 432 over generations 434 for a set of chromosome experiments without chromosome expiration. The x-axis illustrates generations 434 and the y-axis illustrates packing density 432 of a chromosome. After 150 generations in this example, the chromosome mutations tended to get worse packing results.

Some examples of the techniques described herein may determine chromosome expiration by indicating a constant number of generations (e.g., age threshold) and/or by analyzing a slope of the packing density over generation curve. For example, if the slope is trending is close to 0, the probability of the packing density in future generations decreases. Accordingly, a slope threshold may be utilized to determine chromosome expiration in some examples.

In some examples of the techniques described herein, along chromosome mutations across generations, a chromosome age (e.g., time stamp) may be maintained indicating a generation where the root chromosome was discovered (e.g., the generation where the first chromosome appears from the mutations). In some examples, the chromosome age may be utilized to determine a chromosome expiration. In some examples of the techniques described herein, optimization mutations may be utilized (which may aim to optimize a current chromosome, for example) and/or recycling mutations may be utilized (which may aim to get insights from expired chromosomes, for example).

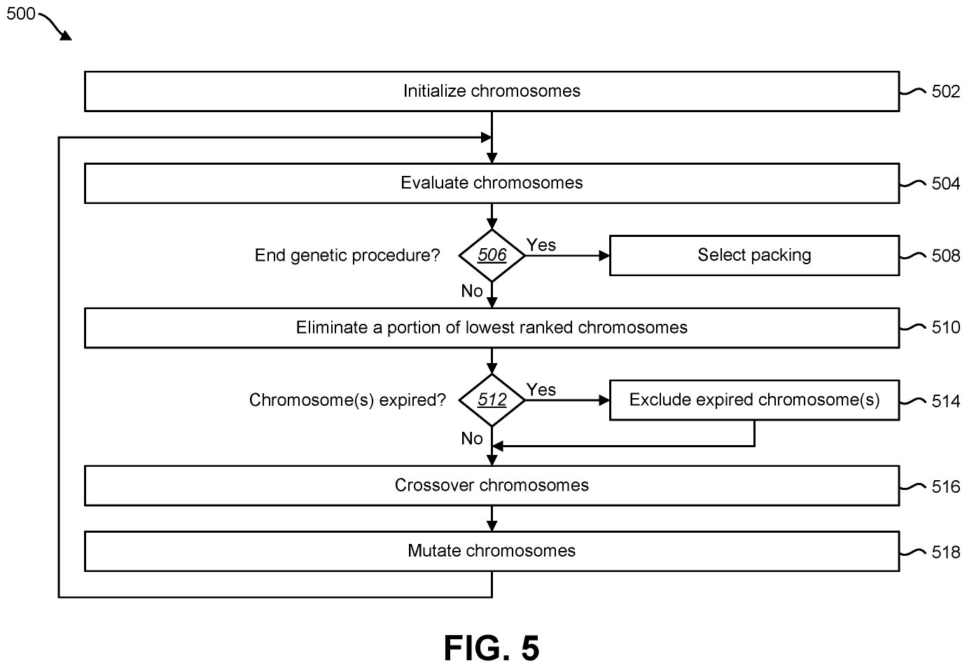

FIG. 5 is a flow diagram illustrating an example of a method 500 to select a packing. The method 500 and/or a method 500 element or elements may be performed by an apparatus (e.g., electronic device). For example, the method 500 may be performed by the apparatus 202 described in relation to FIG. 2. The method 500 may be an example of the method 100 described in relation to FIG. 1. For instance, the method 500 may be an example of a genetic procedure to select a packing.

An apparatus may initialize 502 chromosomes. For example, the apparatus may create chromosomes from a set of objects (e.g., object models). In some examples, initializing 502 the chromosomes may be performed as described in relation to FIG. 1. For instance, the apparatus may determine random orders or sequences of objects (e.g., object identifiers) with random poses (e.g., locations and/or orientations). The order or sequence of object identifiers may be the chromosome identifier for each corresponding chromosome. In some examples, the apparatus may initialize age information (e.g., an age value of 0 or 1, a generation value of 0 or 1, etc.) for each of the initialized chromosomes. The initialized chromosomes may be a population. For instance, the apparatus may create the chromosomes for an initial population size (e.g., 10, 20, 50, 100, 1000, 3500, 4250, 5000, 10000, or 100000 chromosomes, etc.).

The apparatus may evaluate 504 the chromosomes. In some examples, evaluating 504 the chromosomes may be performed as described in relation to FIG. 1. For example, the apparatus may calculate a fitness measure or measures for each chromosome. For instance, the apparatus may calculate a packing density, number of objects packed, packing height, and/or another fitness measure for each chromosome. In some examples, a packing density may be calculated as a volume occupied by the objects arranged according to the chromosome order and poses (e.g., quantity of occupied voxels) divided by a total volume of a cuboid that bounds the objects (e.g., quantity of all voxels in the cuboid). In some examples, other approaches to calculating a packing density may be utilized (e.g., dimension(s) of a cuboid that bounds the object(s), diagonal span length of a cuboid that bounds the object(s), etc.). In some examples, a packing height may be determined as a dimension from a lowest point (e.g., lowest object geometry point) of the packing to a highest point (e.g., highest object geometry point) of the packing. In some examples, the apparatus may look up a fitness measure and/or fitness score for a chromosome or chromosomes. For instance, if a chromosome (e.g., newly produced chromosome) of a current generation matches a chromosome for which a fitness measure and/or fitness score has been calculated, the fitness measure and/or fitness score may be looked up (instead of recalculated, for example). In some examples, the apparatus may utilize a hashing function to look up the fitness measure and/or fitness score based on a chromosome identifier and poses.

In some examples, evaluating 504 the chromosomes may include ranking the chromosomes. For example, the apparatus may rank the chromosomes according to fitness measure and/or fitness score (e.g., a combination of fitness measures) as described herein. A portion of the highest-ranked chromosomes may be categorized as elite chromosomes.

In some examples, the method 500 may include determining a chromosome age and/or a slope. In some examples, determining an age and/or slope may be performed as described in relation to one, some, or all of FIGS. 1-4. For instance, in a case that a chromosome identifier (e.g., order or sequence of object identifiers) is maintained from a last generation (e.g., through mutation), an age of the chromosome may be incremented and/or an initial generation number associated with the chromosome may be maintained. In a case that a chromosome identifier is changed from a last generation (e.g., through mutation), an age of the new chromosome may be initialized (to 0 or a to a current generation number, for instance). In some examples, determining an age may be performed in mutation 518 and/or evaluation 504.

In some examples, determining a slope may be performed based on a chromosome evaluation. For example, a slope may be determined based on a fitness measure and/or fitness score of a chromosome relative to a fitness measure and/or fitness score from a previous generation.

The apparatus may determine 506 whether to end the genetic procedure. In some examples, determining 506 whether to end the genetic procedure may be performed as described in relation to FIG. 1. For instance, the apparatus may determine whether an end condition is satisfied. Some examples of an end condition may be a quantity of generations and/or a fitness threshold, etc. For instance, if a quantity of generations (e.g., 50, 100, 150, 1000, 10000, etc.) has reached a threshold and/or if a target fitness is met (e.g., if a best fitness measure and/or fitness score meets a threshold), the end condition may be satisfied. In a case that the end condition is satisfied, the apparatus may select 508 a packing. For example, the apparatus may select a chromosome with a best fitness measure and/or fitness score from a last generation or a previous generation. The selected chromosome may indicate the selected packing (e.g., order or sequence of objects and poses of objects).

In some examples, the apparatus may manufacture (e.g., print) the objects based on the selected packing and/or may send packing information that indicates the selected packing to another device (e.g., 3D printer) to manufacture (e.g., print) the objects. In some examples, the packing may be executed to manufacture the objects by the apparatus or another device.

In a case that the genetic procedure is not ended (e.g., the end condition is not satisfied), the apparatus may eliminate 510 a portion of lowest ranked chromosomes. In some examples, eliminating 510 the portion of lowest ranked chromosomes may be performed as described in relation to FIG. 1. For instance, the apparatus may eliminate (e.g., discard, delete, remove, exclude, etc.) a portion of the lowest ranked chromosomes (e.g., 10%, 20%, 40%, 60%, etc. of lowest ranked chromosomes, etc.).

The apparatus may determine 512 whether a chromosome is (or chromosomes are) expired. In some examples, determining 512 whether a chromosome is expired may be performed as described in relation to one, some, or all of FIGS. 1-4. For example, the apparatus may compare an age to an age threshold and/or a slope to a slope threshold for a chromosome. The apparatus may exclude 514 each expired chromosome. Excluding a chromosome may be performed as described in relation to one, some, or all of FIGS. 1-4.

In some examples, the apparatus may crossover 516 chromosomes. In some examples, chromosome crossover 516 may be performed as described in relation to FIG. 1. For instance, the apparatus may select (from the remaining unexpired chromosomes, for example) crossover chromosomes from chromosomes ranked below the elite chromosomes. The crossover chromosomes may be utilized to perform crossover with elite chromosomes.

In some examples, the apparatus may mutate 518 chromosomes. In some examples, mutating 518 chromosomes may be performed as described in relation to one, some, or all of FIGS. 1-4. For instance, the apparatus may perform random mutation, optimization mutation, and/or recycling mutation (based on a seed portion of an expired chromosome or seed portions of expired chromosomes, for example). The chromosomes produced by performing crossover 516 and/or mutation 518 may be included in a subsequent generation of chromosomes. In some examples, the apparatus may add random chromosomes. The apparatus may initialize age information for newly created chromosomes and/or chromosomes with different chromosome identifiers relative to a previous generation. The apparatus may increment an age for a chromosome or chromosomes with the same chromosome identifier relative to a previous generation. Operation may return to evaluating 504 chromosomes for a next generation.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be implemented within the scope of the disclosure. For example, aspects or elements of the examples described herein may be omitted or combined.

1. A method, comprising:
generating, in a genetic procedure, chromosomes indicating object packing positions;
determining whether a chromosome of the chromosomes is expired; and
excluding the chromosome from a subsequent generation in response to determining that the chromosome is expired.

2. The method of claim 1, further comprising maintaining age information for each of the chromosomes.

3. The method of claim 2, wherein determining whether the chromosome is expired is based on an age of the chromosome.

4. The method of claim 3, wherein determining whether the chromosome is expired is based on comparing the age to an age threshold.

5. The method of claim 1, further comprising determining a slope of packing density and generation.

6. The method of claim 5, wherein determining whether the chromosome is expired is based on the slope.

7. The method of claim 6, wherein determining whether the chromosome is expired is based on comparing the slope to a slope threshold.

8. The method of claim 1, further comprising randomly rotating poses of a selected chromosome.

9. The method of claim 1, further comprising generating a recycled chromosome based on a seed portion of an expired chromosome.

10. An apparatus, comprising:
a memory;
a processor coupled to the memory, wherein the processor is to:
determine that a chromosome in a genetic procedure is expired;
generate a recycled chromosome based on a seed portion of the expired chromosome; and
select a packing based on the recycled chromosome.

11. The apparatus of claim 10, wherein the processor is to determine that the chromosome is expired based on a slope of packing density over generation of the genetic procedure.

12. The apparatus of claim 10, wherein the processor is to select the packing as a packing with a greatest packing density from a set of chromosomes that includes the recycled chromosome.

13. A non-transitory tangible computer-readable medium storing executable code, comprising:
code to cause a processor to create a chromosome and initialize an age associated with the chromosome;
code to cause the processor to increment the age for each generation of a genetic procedure;
code to cause the processor to exclude the chromosome in a case that the age reaches an age threshold; and
code to cause the processor to determine a packing based on a set of chromosomes that excludes the chromosome.

14. The computer-readable medium of claim 13, further comprising code to cause the processor to randomize a portion of the chromosome in the case that the age reaches the age threshold to produce a recycled chromosome.

15. The computer-readable medium of claim 13, further comprising:
code to cause the processor to randomly select a subset of the chromosome; and
code to cause the processor to randomly rotate poses of the subset of the chromosome.
